(19) United States
(12) Patent Application Publication
(10) Pub. No.: US 2016/0280044 A1
(43) Pub. Date: Sep. 29, 2016

(54) Air Filter for a Ventilation Device of a Motor Vehicle

(71) Applicant: DAIMLER AG, Stuttgart (DE)

(72) Inventor: Tim SCHUENEMANN, Esslingen (DE)

(73) Assignee: Daimler AG, Stuttgart (DE)

(21) Appl. No.: 15/036,732

(22) PCT Filed: Nov. 13, 2014
(86) PCT No.: PCT/EP2014/003041

§ 371 Date: May 13, 2016

(30) Foreign Application Priority Data
Nov. 14, 2013 (DE) 102013019092.4

(51) Int. Cl. B60H 3/06; B01D 46/00; B01D 46/52

(52) U.S. Cl. CPC B60H 3/0616; B01D 46/521; B01D 46/0005; B60H 2003/065; B01D 2279/40

(57) ABSTRACT

An air filter for a ventilation device of a motor vehicle is disclosed. The air filter has respective guides, via which the air filter is able to be connected to the allocated guide pin on a receiving shaft of the ventilation device. The guides are allocated to one another on opposite sides and the associated guide pin, which traverses the air filter, is able to be connected to the guides. An arrangement of such an air filter in a receiving shaft of a ventilation device is also disclosed.

### BACKGROUND AND SUMMARY OF THE INVENTION

The invention relates to an air filter for a ventilation device of a motor vehicle. Furthermore, the invention relates to the arrangement of such an air filter in a receiving shaft of a ventilation device of a motor vehicle.

Such an air filter arranged in a receiving shaft of a ventilation device of a motor vehicle can already be gleaned as known, for example, from DE 10 2005 048 841 B3. Here, two respective guide pins are provided on sides of the receiving shaft of the ventilation device, into which the air filter is able to be plugged or to which it is able to be connected using two respectively corresponding guide means in the form of a plug opening or of a plug dome, forming respective plug connections. Using the generated two plug connections, an accurately positioned holding or arrangement of the air filter within the receiving shaft of the ventilation device is therefore created.

The object of the present invention is to create an air filter as well as an arrangement of such an air filter of the type referred to at the beginning, by means of which an improved arrangement of the air filter within the receiving shaft as well as a more simple assembly of the air filter can be achieved.

In order to create an air filter of the type referred to at the beginning which has improved functionality within the receiving shaft and moreover can be better assembled within the receiving shaft, it is provided according to the invention that the air filter has guide means which are allocated to one another on opposite sides, by means of which the associated guide pin which traverses the air filter is able to be connected. In other words, the air filter is formed according to the invention in such a way that at least one guide pin can be provided on sides of the receiving shaft, the guide pin completely traversing the air filter and, as a consequence, being able to be plugged into or engage with or be connected in another way to the respectively allocated guide means of the air filter on the opposite sides. In particular, here, the respective guide means on the opposite sides of the air filter are, for example, respective guide openings into which the guide pin can be plugged on sides of the receiving shaft. However, in the scope of the invention it can be considered to be included that other guide means are, of course, also conceivable, for example blind hole-type guide thorns or similar.

Since the air filter is therefore traversed by the guide pin, in particular two substantial advantages result:

On the one hand, the guide pins, for example, are used to stabilize a filter medium, such as, for example, a filter fleece, such that this is not deformed as a consequence, for example, of the effect of suction or pressure of the fan of the ventilation device or is not removed or detached from the remaining parts of the air filter, in particular from a filter frame, and therefore malfunctions or a breakdown of the ventilation system cannot occur.

On the other hand, using the guide pins—which traverse the air filter completely—a more simple assembly of the air filter within the receiving shaft can also be achieved. In particular, after insertion on a side of the corresponding air filter—for example by a corresponding pleating of the filter medium or filter fleece—the guide pin can serve as a guide, along which the air filter can be displaced until the free end or the tip of the guide pin engages with the corresponding guide means, for example a corresponding guide opening, on the opposite side of the air filter. The insertion of the air filter can thereby occur in a particularly low-force manner, wherein, due to a suitable design of the filter medium, for example by a suitable pleating, the free end or the tip of the guide pin inevitably engages with the guide means on the opposite side of the air filter. The guide means engaging with the guide pin at the end of the insertion movement can also make the correct final assembly position of the filter recognizable with a visible or tangible engagement of the guide pin.

In a further embodiment of the invention, it has thereby been shown to be advantageous if the guide means allocated to one another on opposite sides of the air filter are formed as respective plug openings into which the corresponding guide pin is able to be plugged. Plug openings are able to be produced particularly cost-effectively and are functionally secure due to definable support with cross-sections of the plug opening and guide thorn which are adapted to each another.

These two plug openings or guide means thereby preferably run in a common alignment with regard to the insertion direction or with regard to the course of the guide thorn, and in particular coaxially to each other, such that a straight-line insertion movement automatically leads to the guide means or the plug opening of the air filter which, in the assembled state of the filter, engages with the free end of the guide thorn, being met in a simple manner. In the case of a curved guide pin, the plug openings can be arranged coaxially with regard to the allocated engagement region of the guide pin, but to be offset with respect to each another and/or not in a common alignment with regard to the respective other plug opening.

A further advantageous embodiment provides that the air filter has frame elements on the opposite sides in the insertion direction, or connected front surfaces, on which frame elements a filter element is held or the frame elements being formed by a corresponding arrangement or processing of the filter element. Here, these frame elements have the respective guide means or plug openings. In a specific embodiment, these can be frame elements which are designed as sections of a one-piece circumferential frame. Such a one-piece frame enables a particularly good holding of the respective filter element. A frame or frame elements ensure an improved guiding and holding of the air filter on the corresponding guide pins by their stiffening effect in the structure of the filter.

In a further embodiment of the invention, the filter element is adapted to the guide pin which traverses the air filter and is able to be supported on this in the assembly position. This means, in particular, that the filter element is designed in such a way that it abuts onto the guide pin in a supporting manner at least in regions, or is at a distance in regions, such that it can abut onto the guide pin in a supporting manner without substantial deformation. In a particular embodiment, the air filter can, for example, be traversed by the guide pin through a suitable pleating.

Furthermore, it is advantageous if the filter element has a pleating, the fold edges of which run substantially parallel to the extension direction of the guide pin which traverses the air filter. Therefore, the pleating can serve, in a simple manner, as a guide for the free end or the tip of the guide pin during insertion of the air filter into the receiving shaft.

Finally, it has been shown to be advantageous if an assembly aid is arranged on the guide means arranged on the opposite side of the air filter in the insertion direction of the guide pin, so the guide means which is able to engage with the free end of the guide pin in the inserted position of the filter. Using this assembly aid, the free end or the tip of the guide pin is able to engage with the corresponding guide means or the corresponding plug opening in a simple and improved manner during insertion of the air filter into the receiving shaft. The assembly aid can thereby be executed as a guide collar which is formed at least in regions and which comprises the guide pin. Alternatively, the assembly aid can be executed as a thorn which engages with an opening or recess of the thorn. Likewise, the assembly aid can be designed as a guide rib which engages, for example, with the guide pin with a sloped edge. In this embodiment, for example, a guide pin having a U- or V-shaped bar profile can engage in a particularly advantageous manner with an assembly aid designed as a guide rib. These embodiments are, particularly advantageously, able to be adapted to assembly and functional conditions, such as, for example, the installation and assembly position of the filter with regard to the assembly environment or the effect of the weight force, admissible obstructions in flow and cross-section of the guide pin, necessary stiffness and support effect of the guide pin.

In order to enable an improved sealing of the filter, the guide means which is able to engage with the free end of the guide pin in the inserted position of the filter, and possibly the associated assembly aid, can be formed by an insert dome, so a blind-type closed insert shaft.

The advantages referred to above in connection with the air filter according to the invention apply in the same way to the arrangement.

Further advantages, features and details of the invention arise from the subsequent description of a preferred exemplary embodiment, as well as by means of the drawings.

### BRIEF DESCRIPTION OF THE DRAWINGS

FIG. 1 is a sectional perspective view onto an air filter for a ventilation device of a motor vehicle, the air filter comprising a frame having several frame elements on which frame a filter element in the form of a filter fleece having a corresponding pleating is held;

FIG. 2 is a sectional perspective view onto the air filter according to FIG. 1, wherein a part of the frame, in particular two guide pins, are recognizable on sides of the receiving shaft, the guide pins working together with respective guide means on the sides of the air filter, wherein the guide means are arranged in respective frame elements as plug openings on opposite sides of the air filter, and to which the respectively associated guide pin which completely traverses the air filter is able to be connected by producing a plug connection; and

FIG. 3 is a perspective view onto the air filter according to FIGS. 1 and 2 with an omitted filter medium or filter fleece, whereby the two guide pins allocated to the receiving shaft are recognizable, which completely traverse the air filter and engage with the respective guide means in the form of the plug openings within the allocated frame elements on the opposite sides of the air filter, and wherein respective assembly aids are recognizable, by means of which respective free ends of the guide pins are able to be introduced into the corresponding plug openings of the air filter.

### DETAILED DESCRIPTION OF THE DRAWINGS

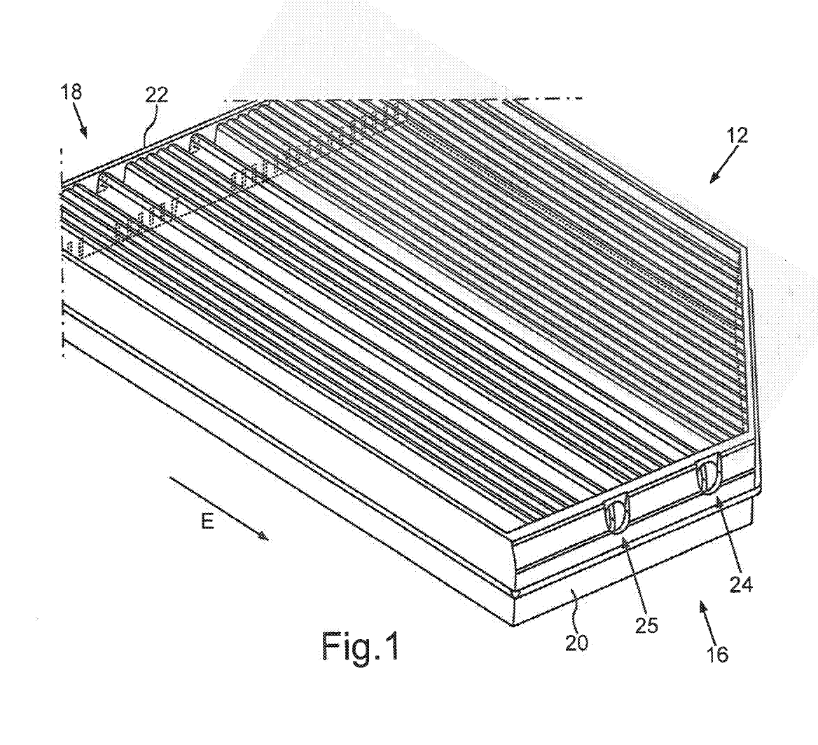

In FIG. 1, in a sectional perspective view, an air filter for a ventilation device of an interior of a motor vehicle is depicted. The ventilation device itself can here be allocated to a heating and/or air conditioning system, wherein any other ventilation devices for a motor vehicle are also conceivable. The air filter usually serves to purify air, which is sucked in from outside the motor vehicle and is to be supplied to the interior—conditioned accordingly. Of course, other types of air filter would also be conceivable.

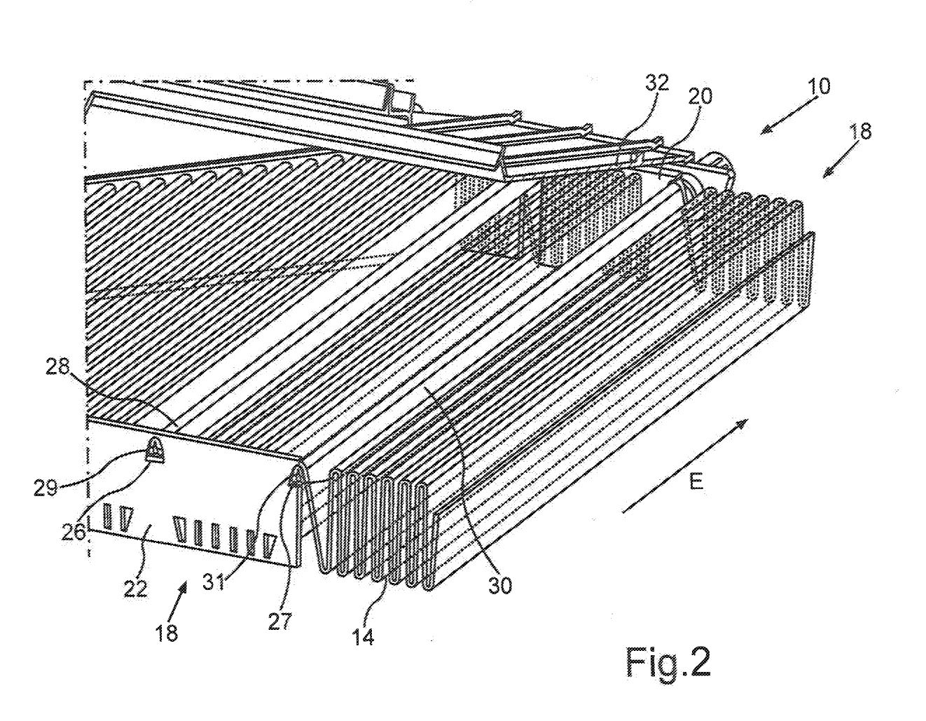

This air filter is depicted in FIG. 2 in its arrangement within a receiving shaft 10 of the ventilation device in a sectional perspective view. Here, the receiving shaft 10 is usually a part of a so-called air conditioning box.

The air filter presently comprises a circumferential frame 12 which is produced, for example, from a plastic or possibly also from a paper material or another material. Using this frame 12, a filter element 14 in the form of a filter fleece or similar is supported, which—as is recognizable from FIG. 2—has a corresponding pleating, so corresponding fold layers. For better recognition of this pleating, the frame 12 is depicted in a partially cut manner in FIG. 2. In particular, it is moreover recognizable from FIG. 2 that the pleating is adapted approximately to the height of the individual frame elements of the frame 12 and extends in the same direction as the guide pins 28, 30.

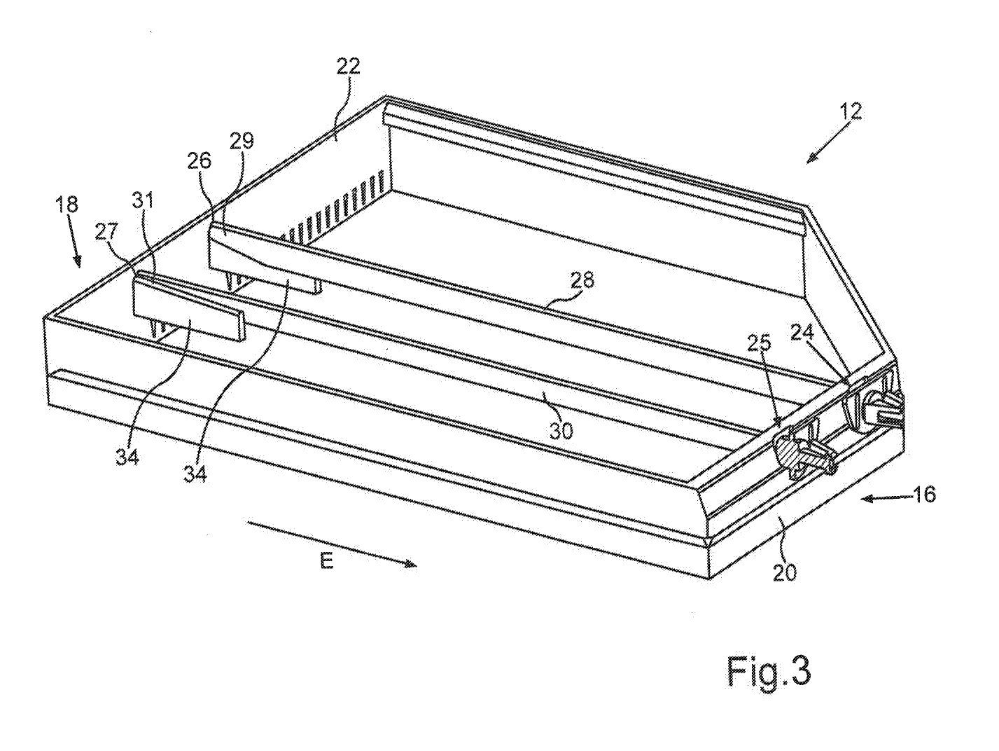

By means of FIG. 3, which shows the frame 12 with an omitted filter element, it is in particular recognizable that respective frame elements 20, 22 are provided on opposite sides 16, 18 of the air filter running approximately parallel to each other, the frame elements each having two guide means 24, 25 and 26, 27, which are formed as a plug openings.

As is recognizable when FIGS. 2 and 3 are seen together, a corresponding guide pin 28 is able to be plugged into the plug openings 24 and 26 and a further guide pin 30 is able to be inserted into the two plug openings 25, 27. These two guide pins 28, 30 are here fastened to a corresponding housing 32 on sides of the receiving shaft 10, as is recognizable in particular from FIG. 2.

As is recognizable in particular from FIG. 2 and FIG. 3, these two guide pins 28, 30 completely traverse the air filter. If, therefore, as a consequence, the air filter is inserted into the receiving shaft 10 in an insertion direction E depicted with an arrow, then respective free ends 29 or 31 of the guide pins 28, 30 are firstly plugged into the corresponding plug openings 24, 25 on the corresponding frame element 20. By further insertion in the insertion direction E, the guide pins 28, 30 are presently moved along the filter element 14 until the free ends 29 or 31 of the guide pins 28, 30 finally engage with the plug openings 26, 27 on the frame element 22 lying opposite the frame element 20, forming respective plug connections. A particular feature of the present arrangement of the air filter within the receiving shaft 10 therefore consists in that the shaft-side guide pins 28, 30 completely traverse the air filter or the frame 12 thereof and are connected to the corresponding guide means—the plug openings 26, 27—with their free ends 29 or 31 on the opposite side 18 of the air filter—when observed in the insertion direction E.

As is recognizable from FIG. 2, the guide pins 28, 30 are adapted to the shape of the pleating of the filter element 14 in their substantially roof-like or triangular cross-section. As a consequence, the respective guide means 24 to 27 in the form of the plug openings within the respective frame elements 20, 22 are also likewise formed to be triangular.

The adaptation of the filter element 14 or of the pleating to the guide pins 28, 30 enables the filter element 14, over the entire extension thereof between the two frame elements 20, 22, to be supported on the respective guide pins 28, 30 in the installation position of the air filter on the receiving shaft 10. Therefore, in particular during the operation of a fan of the ventilation device during which corresponding forces act on the filter element 14 as a consequence of the effect of suction or pressure, a particularly favorable support results. For this purpose, the guide pins 28, 30—when observed in the through-flow direction of the air through the filter element 14—are preferably arranged behind the filter element 14. The filter element 14 therefore cannot be detached from the frame 12, which could possibly lead to malfunctions or a complete breakdown of the ventilation device. Rather, a grill-like support of the filter element 14 presently results here through the guide pins 28, 30, such that transverse forces as a consequence of an air flow which traverses the air filter or the filter element 14 cannot lead to corresponding deformations of the filter element 14.

A further advantage of the guide pins 28, 30 which traverse the air filter completely also results during the assembly. The guide pins 28, 30 can be pushed, in particular in the case of the present air filter, along the guide of the filter element 14 respectively formed by the pleating, until the free ends 29, 31 of the guide pins 28, 30 reach the corresponding plug openings 26, 27 on the opposite side 18 in the course of the insertion movement in the insertion direction E.

As is recognizable in particular from FIG. 3, in the region of the guide means or plug openings 26, 27, which correspond to the free ends 29, 31 of the guide pins 28, 30, respective strut-like assembly aids 34 are provided. During displacement of the air filter on the guide pins 28, 30, these assembly aids 34 enable a simple plug connection of the respective free ends 29, 31 of the guide pins 28, 30 with the corresponding plug openings 26, 27. The respective plug openings 26, 27 can moreover be formed by an insertion dome, wherein, for example, the respective guide pins 28, 30 taper in cross-section at their free ends 29, 31. The plug openings 26, 27 can also have corresponding rounding or sloping such that a simple introduction or plugging-in of the respective free ends 29, 31 into the corresponding frame element 22 can be enabled.

1.-9. (canceled)

10. An air filter for a ventilation device of a motor vehicle, comprising:
a frame; and
a first guide and a second guide, wherein the first guide and the second guide are disposed on opposite sides of the frame and wherein the air filter is connectable to a guide pin that completely traverses the air filter and that is disposed on a receiving shaft of the ventilation device via the first guide and the second guide.

11. The air filter according to claim 10, wherein the first guide and the second guide are respective plug openings into which the guide pin is insertable.

12. The air filter according to claim 10, wherein the first guide and the second guide are disposed on a same axis.

13. The air filter according to claim 10, wherein the frame has a first frame element and a second frame element, wherein the first guide is disposed on the first frame element and the second guide is disposed on the second frame element, and wherein a filter element is held on the first frame element and the second frame element.

14. The air filter according to claim 13, wherein the filter element is adapted to the guide pin and is supportable on the guide pin in an installation position.

15. The air filter according to claim 13, wherein the filter element has a pleating and wherein fold edges of the pleating run in an extension direction of the guide pin.

16. The air filter according to claim 10, wherein an assembly aid is associated with the second guide, wherein the second guide is disposed on an opposite side of the air filter in an insertion direction of the guide pin, and wherein the second guide is engagable with a free end of the guide pin in an inserted position of the air filter.

17. The air filter according to claim 10, wherein the second guide is disposed on an opposite side of the air filter in an insertion direction of the guide pin and wherein the second guide is an insertion dome.

18. The air filter according to claim 10, further comprising:
a third guide and a fourth guide, wherein the third guide and the fourth guide are disposed on opposite sides of the frame and wherein the air filter is connectable to a second guide pin that completely traverses the air filter and that is disposed on the receiving shaft of the ventilation device via the third guide and the fourth guide.

19. An arrangement of an air filter in a receiving shaft of a ventilation device of a motor vehicle, comprising:
an air filter, wherein the air filter includes:
a frame; and
a first guide and a second guide, wherein the first guide and the second guide are disposed on opposite sides of the frame; and
a guide pin on the receiving shaft of the ventilation device, wherein guide pin is received in the first guide and the second guide of the air filter and wherein the guide pin completely traverses the air filter.

20. The arrangement according to claim 19, wherein the first guide and the second guide are respective plug openings.

21. The arrangement according to claim 19, wherein the first guide and the second guide are disposed on a same axis.

22. The arrangement according to claim 19, wherein the frame has a first frame element and a second frame element, wherein the first guide is disposed on the first frame element and the second guide is disposed on the second frame element, and wherein a filter element is held on the first frame element and the second frame element.

23. The arrangement according to claim 22, wherein the filter element is adapted to the guide pin and is supported on the guide pin.

24. The arrangement according to claim 22, wherein the filter element has a pleating and wherein fold edges of the pleating run in an extension direction of the guide pin.

25. The arrangement according to claim 19, wherein an assembly aid is associated with the second guide and wherein the second guide is disposed on an opposite side of the air filter in an insertion direction of the guide pin.

26. The arrangement according to claim 19, wherein the second guide is disposed on an opposite side of the air filter in an insertion direction of the guide pin and wherein the second guide is an insertion dome.

27. The arrangement according to claim 19:
wherein the air filter includes a third guide and a fourth guide, wherein the third guide and the fourth guide are disposed on opposite sides of the frame;
and further comprising a second guide pin on the receiving shaft of the ventilation device, wherein second guide pin is received in the third guide and the fourth guide of the air filter and wherein the second guide pin completely traverses the air filter.
